(19) United States
(12) Patent Application Publication
(10) Pub. No.: US 2026/0257735 A1
(43) Pub. Date: Sep. 3, 2026

(54) Automotive vehicle with press hardened visible steel parts

(71) Applicant: ArcelorMittal, Luxembourg (LU)

(72) Inventors: Guillaume PLANCHON, SAINT-AVOLD (FR); Marine KIEFFER, Boulay (FR); Larissa AGRIZZI RONQUETI, Metz (FR); Eric JACQUESON, Longeville-Les-Metz (FR); Tiago MACHADO AMORIM, Longeville Les (FR)

(21) Appl. No.: 18/879,698

(22) PCT Filed: Jul. 25, 2023
(86) PCT No.: PCT/IB2023/057520

§ 371 Date: Dec. 27, 2024

(30) Foreign Application Priority Data
Jul. 28, 2022 (WO) PCT/IB2022/056969

(51) Int. Cl. B62D 29/00; C21D 1/78

(52) U.S. Cl. CPC B62D 29/007; C21D 1/78; C21D 2211/002; C21D 2211/005; C21D 2211/008

(57) ABSTRACT

An automobile, wherein at least one outer skin part or one semi-visible part is made of coated press hardened steel, the coating of the steel before heating and press hardening containing by weight, 8 to 12% of Silicon, up to 3% Iron, and unavoidable impurities up to 0.1%, the balance being Aluminum, and wherein the coating has a thickness from 10 to 20 μm per side.

The invention relates to a process for manufacturing press hardened parts of coated steel having an improved appearance, more particularly intended to be used for the manufacture of exposed or semi-exposed parts for automobiles, without however being limited thereto.

### BACKGROUND

In recent years the use of coated steels in hot-stamping processes for the shaping of parts has become important, especially in the automotive industry. Fabrication of such parts may include the following main steps:
Coating of steel sheets, by hot dipping
Trimming or cutting for obtaining blanks
Heating the blanks to transform the steel microstructure into austenite.
Hot forming followed by rapid cooling of the part to obtain predominantly a martensitic structure.

Press hardened steel parts intended for the manufacture of automobiles are generally coated with an aluminum-based metallic coating, which sustains both the austenitizing heat treatment and the subsequent press hardening step itself. After hot deformation and quenching of the part, the coating provides protection against corrosion. Said coating is deposited by hot-dip coating in a liquid bath.

Press hardened steel parts intended for the manufacture of automobiles can be deep drawn at high temperatures and are quenched in the forming tools to reach the targeted microstructure. In terms of material properties, tensile strength from 500 to 2000 MPa and tensile elongation from 5 to 15% can be achieved. Press hardened steel parts offer the major advantage of combining good formability with very high strength.

### SUMMARY OF THE INVENTION

Press hardened parts are then assembled, to form a body in white, which is then coated with at least one paint coat, thereby providing greater corrosion protection.

Compared to the aspect achieved by cold stamped galvanized steel material, the surface aspect of press hardened steel parts remains poor. Paint layers tend to reduce surface irregularities. But even after painting, press hardened parts can't be used for outer skin parts because of surface defects and corresponding detrimental appearance. This is because press hardened coated steel parts have various defects, such as wavy surfaces. After painting, the parts would have an unacceptable appearance, for example locally similar to “orange peel”.

Besides outer-skin parts, semi-visible parts are only visible when the doors of the vehicle are open. Press-hardened parts are not suitable to manufacture semi-visible part.

For the reasons explained above, press-hardened parts are not directly exposed to the customer's gaze but covered by an additional metal part with a better appearance. Said additional part has no or very little mechanical function but a cosmetic function. It acts as a screen and makes the press-hardened part invisible to the eye. For example, the part called body-side is usually manufactured in one large piece having very good visual aspect. This cosmetic body-side part acts as a screen and covers the structural parts from the front to the rear wheel.

The waviness W of the surface is a gentle, pseudoperiodic, geometric irregularity of quite a long wavelength (0.8 to 10 mm), distinguished from the roughness R, which corresponds to geometric irregularities of short wavelengths (<0.8 mm).

In the present invention, the arithmetic mean Wa of the waviness profile, expressed in μm, is used to characterize the surface waviness of the sheet, and the waviness measurements with cut-off thresholds of 2.5 mm to 8.0 mm are denoted by Wa_{2.5-8}.

An aim of the invention therefore to provide an automobile manufactured with at least one press hardened coated steel part, the waviness Wa_{2.5-8} of which is reduced compared to press hardened parts of the prior art.

The present invention provides an automobile, wherein at least one outer skin part or at least one semi-visible part is made of coated press hardened steel, the coating of said steel before heating and press hardening containing by weight, 8 to 12% of Silicon, up to 3% Iron, and unavoidable impurities up to 0.1%, the balance being Aluminum, and wherein said coating has a thickness from 10 to 20 μm per side.

For this purpose, the invention also discloses a process for manufacturing press hardened coated steel part, comprising the following steps:
A) Supplying a steel sheet, steel sheet having a thickness from 0.7 to 2.5 mm,
B) Coating said steel sheet by hot dipping into an Aluminum based liquid metallic bath containing by weight, 8 to 12% of Silicon, up to 3% Iron, and unavoidable impurities from the manufacturing process up to 0.1%, wherein said coating has a thickness from 10 to 20 μm per side,
C) Temper rolling the coated steel sheet at a total elongation from 0.1 to 1.2%, the elongation being defined by the speed difference between the material in and the material out of the temper rolling stand,
D) Cutting said coated, temper rolled steel sheet to obtain a blank,
E) Heating said blank at a temperature from 800 to 970° C., to obtain a fully austenitic microstructure in the steel,
F) Transferring the blank into a press tool,
G) Press hardening of said blank to obtain a press hardened part.

In step A), any steel can be used in the frame of the invention. However, in case steel having high mechanical strength is needed, in particular for parts of structure of automotive vehicle, steel having a tensile resistance superior to 500 MPa, advantageously between 500 and 2000 MPa before or after heat-treatment, can be used. The weight composition of steel sheet is preferably as follows: 0.03%≤C≤0.50%; 0.3%≤Mn≤3.0%; 0.05%≤Si≤0.8%; 0.015%≤Ti≤0.2%; 0.005%≤Al≤0.1%; 0%≤Cr≤2.50%; 0%≤S≤0.05%; 0%≤P<0.1%; 0%≤B≤0.010%; 0%≤Ni≤2.5%; 0%≤Mo≤0.7%; 0%≤Nb≤0.15%; 0%≤N≤0.015%; 0%≤Cu≤0.15%; 0%≤Ca≤0.01%; 0%≤W≤0.35%, the balance being iron and unavoidable impurities from the manufacture of steel.

For example, the steel sheet is 22MnB5 with the following weight composition: 0.20%≤C≤0.25%; 0.15%≤Si≤0.35%; 1.10%≤Mn≤1.40%; 0%≤Cr≤0.30%; 0.020%≤Ti≤0.060%; 0.020%≤Al≤0.060%; 0.002%≤B≤0.004%, the balance being iron and unavoidable impurities from the manufacture of steel.

In another embodiment, the steel sheet has the following weight composition: 0.24%≤C≤0.38%; 0.40%≤Mn≤3%; 0.10%≤Si≤0.70%; 0.015%≤Al≤0.070%; Cr≤2%; 0.25%≤Ni≤2%; 0.015%≤Ti≤0.10%; Nb≤0.060%; 0.0005%≤B≤0.0040%; 0.003%≤N≤0.010%; S≤0.005%; P≤0.025%; the remainder being iron and unavoidable impurities resulting from the manufacture of steel.

Alternatively, the steel sheet can have the following weight composition: 0.30%≤C≤0.40%; 0.5%≤Mn≤1.0%; 0.40%≤Si≤0.80%; 0.1%≤Cr≤0.4%; 0.1%≤Mo≤0.5%; 0.01%≤Nb≤0.1%; 0.01%≤Al≤0.1%; 0.008%≤Ti≤0.003%; 0.0005%≤B≤0.003%; 0.0%≤P≤0.02%; 0.0%≤Ca≤0.001%; 0.0%≤S≤0.004%; 0.0%≤N≤0.005%, the remainder being iron and unavoidable impurities resulting from the manufacture of steel.

In another embodiment, the steel sheet has the following weight composition: 0.040%≤C≤0.100%; 0.80%≤Mn≤2.00%; 0%≤Si≤0.30%; 0%≤S≤0.005%; 0%≤P≤0.030%; 0.010%≤Al≤0.070%; 0.015%≤Nb≤0.100%; 0.030%≤Ti≤0.080%; 0%≤N≤0.009%; 0%≤Cu≤0.100%; 0%≤Ni≤0.100%; 0%≤Cr≤0.100%; 0%≤Mo≤0.100%, the balance being iron and unavoidable impurities from the manufacture of steel.

In another embodiment, the steel sheet has the following weight composition: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the manufacture of steel.

In another embodiment, the steel sheet has the following weight composition: 0.015%≤C≤0.25%; 0.5%≤Mn≤1.8%; 0.1%≤Si≤1.25%; 0.01%≤Al≤0.1%; 0.1%≤Cr≤1.0%; 0.01%≤Ti≤0.1%; 0%≤S≤0.01%; 0.001%≤B≤0.004%; 0%≤P≤0.020%; 0%≤N≤0.01%; the balance being iron and unavoidable impurities from the manufacture of steel.

Alternatively, the steel sheet has the following weight composition: 0.2%≤C≤0.34%; 0.5%≤Mn≤1.24%; 0.5%≤Si≤2.0%; 0%≤S≤0.01%; 0%≤P≤0.020%; 0%≤N≤0.01%, the balance being iron and unavoidable impurities from the manufacture of steel.

Steel sheet can be obtained by hot rolling and optionally cold rolling depending on the desired thickness. Thickness below 0.5 mm may tear off during hot forming process. Press hardened parts thicker than 3.0 mm are not needed in the automotive body.

In step B), the steel sheet is then hot dip coated in a molten bath and subsequently wiped by air knifes to adjust the coating thickness. If the coating thickness is below 10 μm per side, the corrosion performance is not sufficient. If the coating thickness is above 20 μm per side, the waviness Wa_{2.5-8} of the stamped part is too high.

In step C), the steel sheet is then temper-rolled. The temper rolling operation occurs on a single stand temper rolling mill, wherein the steel strip is rolled between the two working rolls of said mill. A pressure force is applied on the steel strip by the work rolls, which in turn exert a lineic pressure along the generatrix in contact with the strip. The elongation rate at the temper rolling mill is given by the relative difference of the material speed rolling out of the temper rolling stand minus the material speed rolling into said stand. If the elongation is below 0.1%, punctual surface defects will be visible on the steel sheet on the final press hardened part as well. If the elongation is above 1.2%, the waviness Wa of the press hardened part will be too high. Indeed, inventors have surprisingly found that a temper rolling elongation rate above 1.2% induces a waviness Wa_{2.5-8} of the press hardened part of more than 0.41 μm. Without to be bound by theory, it seems that decreasing the temper rolling elongation also decreases the waviness of the press hardened part.

Preferably, the elongation rate in step C) is 0.9% or less, more preferably 0.7% or less, advantageously 0.5% or less, or even 0.3% or less.

In the automobile according to the present invention, the press-hardened part has a waviness Wa_{2.5-8} below 0.41 μm, preferably below 0.35 μm, or even below 0.29 μm.

Press hardened parts in an automobile according to the invention are suitable for outer skin parts.

Thanks to the invention, the cosmetic parts hiding the press hardened parts can be suppressed. For example, the invention allows to suppress the body-side 6.

### BRIEF DESCRIPTION OF THE DRAWING

FIG. 1 shows an automobile with the following labels: 1: A-Pillar, 2: B-Pillar, 3: C-Pillar, 4: Side Sill, 5: Roof Rail, 6: Body-side and having at least one outer skin part or at least one semi-visible part made of coated press hardened steel.

### DETAILED DESCRIPTION

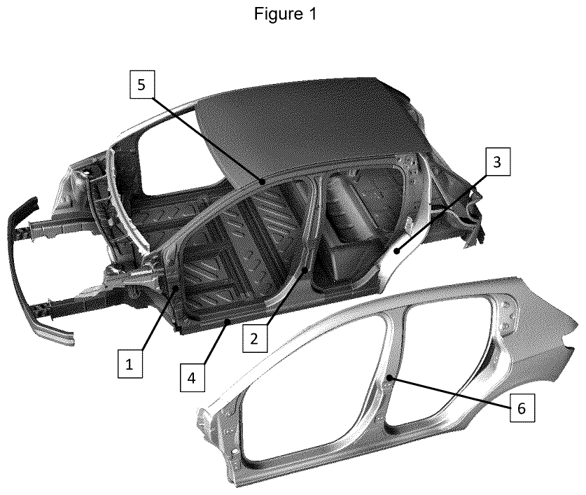

Press hardened parts in an automobile according to the invention are also suitable for semi-visible parts. For example, the invention is suitable for the following semi-visible parts of an automobile shown in FIG. 1 for example that are only visible when the doors are open: A-pillar 1, B-pillar 2, C-pillar 3, side sill 4, or roof rail 5.

For example, the invention is also suitable for semi-visible parts comprised in the hatchback of an automobile that are only visible when the rear tailgate is open.

The press hardened part used in an automobile according to the invention can have various types of microstructure, depending on the targeted mechanical properties, especially the yield strength and tensile strength. For instance, the press hardened part has a steel microstructure comprising, in terms of volume fraction, at least 95% of martensite, when a high resistance is needed. The press hardened part can also have a microstructure comprising at least 50% of martensite and less than 40% of bainite. This is the case for parts located in the automobile where both resistance and deformation are needed. Allowing deformation in the event of a crash is a design technique to absorb the crash energy. Finally, the press hardened part can have a microstructure comprising from 5 to 20% of martensite, up to 10% of bainite and at least 75% of equiaxed ferrite for parts having an anti-intrusion function.

The invention will now be explained in trials carried out for information only. They are not limiting.

### EXAMPLES

For all samples, carbon steel coils used are 22MnB5. The composition of the steel is as follows: C=0.23%; Mn=1.2%; Si=0.25%; %; Cr=0.2%; Al=0.04%; Ti=0.04%; B=0.003%.

All steel coils were continuously rolled to desired thickness. After rolling, they were annealed and continuously coated with a coating deposited by hot dipping in a metallic bath. This coating comprises 9% by weight of Silicon, 3% by weight of iron, the balance being aluminum.

After hot-dip aluminizing, the steel coils were temper rolled at different elongations. The temper rolling operation occurs on a single stand temper rolling mill, wherein the steel strip is rolled between the two working rolls of said mill. The elongation rate at the temper rolling mill is given by the relative difference of the material speed rolling out of the temper rolling stand minus the material speed rolling into said stand.

As the test progresses, the Wa_{2.5-8} waviness values are measured. This measurement consists in acquiring by mechanical palpation, without skid, a profile of the sheet of a length of 40 mm, measured in the direction transversal to the direction of rolling. The long-wave components corresponding to the form are separated using a Gaussian filter with a cutoff of 8 mm. The waviness Wa is then isolated from the low-wave components, including roughness Ra by a Gaussian filter with a cutoff of 2.5 mm. The gaussian filters used are defined in the standard ISO 16610-21:2012.

### Example 1: Hot-Stamping Test

The steel sheets were cut into rectangular blanks having the following dimension: 200×250 mm². Then each blank was heated in a furnace at 900° C. for 345 to 405 seconds, depending on the material thickness. After heating, each blank was transferred into a flat tool composed of two plates. The plates were cooled with circulating water. Temperature set point of the cooled water circuit was 17° C. Tool pressing force between the two plates was 50 T.

The waviness Wa_{2.5-8} corresponding to each temper elongation was measured on the temper rolled steel sheets. Results are disclosed in table 1.

TABLE 1

| | | | HEAT | |
|---|---|---|---|---|
| | | | TREATMENT | Wa_{2.5-8} |
| | | TEMPER | Furnace at | (μm) |
| | Sheet | ROLLING | 900° C. | AFTER |
| TRIAL | Thickness | Elongation | Dwell Time | Press |
| Nr | (mm) | rate (%) | (seconds) | Hardening |
| 1 | 1.61 | 1.3 | 390 | 0.42 |
| 2* | 1.61 | 1.2 | 345 | 0.29 |
| 3* | 1.62 | 0.9 | 390 | 0.37 |
| 4* | 1.61 | 0.3 | 345 | 0.27 |

*examples according to the invention,
underlined values are not according to the invention

1-7. (canceled)

8: An automobile comprising:
at least one outer skin part or at least one semi-visible part made of coated press hardened steel having a coating and a base steel, the coating before heating and press hardening containing by weight, 8 to 12% of Silicon, up to 3% Iron, and unavoidable impurities up to 0.1%, a balance being Aluminum, the coating having a thickness from 10 to 20 μm per side.

9: The automobile as recited in claim 8 wherein the at least one semi-visible part is chosen from among the group consisting of: A-pillar, B-pillar, C-Pillar, roof rail and side sill.

10: The automobile as recited in claim 8 wherein the at least one outer skin part or at least one semi-visible part has a waviness Wa_{2.5-8} below 0.41 μm after press hardening.

11: The automobile as recited in claim 10 wherein the at least one outer skin part or at least one semi-visible part has a waviness Wa_{2.5-8} below 0.35 μm after press hardening.

12: The automobile as recited in claim 8 wherein the microstructure of the at least one outer skin part or at least one semi-visible part after press hardening comprises, in terms of volume fraction, at least 95% of martensite.

13: The automobile as recited in claim 8 wherein the microstructure of the at least one outer skin part or at least one semi-visible part after press hardening comprises, at least 50% of martensite and less than 40% of bainite.

14: The automobile as recited in claim 8 wherein the microstructure of the at least one outer skin part or at least one semi-visible part after press hardening comprises from 5 to 20% of martensite, up to 10% of bainite and at least 75% of equiaxed ferrite.
